(19) United States
(12) Patent Application Publication
(10) Pub. No.: US 2026/0199983 A1
(43) Pub. Date: Jul. 16, 2026

(54) TUBE MULTI-POINT INCREMENTAL FORMING APPARATUS AND METHOD

(71) Applicants: Nanjing University of Aeronautics and Astronautics, Nanjing (CN); Wuxi Research Institute, Nanjing University of Aeronautics and Astronautics, Wuxi (CN)

(72) Inventors: Xunzhong GUO, Nanjing (CN); Chunmei LIU, Nanjing (CN); Hui WANG, Nanjing (CN); Cheng CHENG, Nanjing (CN); Qiucheng YANG, Nanjing (CN); Yifan ZHA, Nanjing (CN); Tao TAO, Nanjing (CN); Yun WANG, Nanjing (CN); Zexiong ZHANG, Nanjing (CN)

(73) Assignees: Nanjing University of Aeronautics and Astronautics, Nanjing, JS (CN); Wuxi Research Institute, Nanjing University of Aeronautics and Astronautics, Wuxi, JS (CN)

(21) Appl. No.: 19/565,475

(22) Filed: Mar. 12, 2026

(30) Foreign Application Priority Data
Mar. 13, 2025 (CN) 202510297173.2

(51) Int. Cl. B23B 5/08

(52) U.S. Cl. CPC B23B 5/08

(57) ABSTRACT

Disclosed is a tube multi-point incremental forming apparatus and method, including a tube feed apparatus and a forming apparatus. The tube feed apparatus and the forming apparatus are installed on a computer numerical control machine tool workbench (8); the forming apparatus includes a large gear (2), a small gear (19) and multiple sets of independent tool devices, each set of tool devices includes a tool head (16) and a tool head motor (18), the tool head (16) is fixed on the large gear (2), which can change its radial angle with the large gear (2) to change the initial angle of the three tool heads. The device is configured to allow multiple tool heads to process different parts at the same time to achieve efficient processing.

### TECHNICAL FIELD

The present disclosure relates to the field of incremental forming technology, in particular to a tube multi-point incremental forming apparatus and method.

### BACKGROUND

Incremental tube forming is an incremental local deformation method to obtain the required shape and performance requirements of formed parts. This processing method can be used to obtain a given part shape through a simple shape tool moving along a specific trajectory, and can form more complex parts without a special mold. Compared with traditional stamping methods, it has the advantages of great flexibility, saving the manufacturing cost of complex molds and improving the forming performance of materials, it is very suitable for the production of small batches and multi-variety parts, as well as the trial production of samples.

Currently, an incremental forming apparatus is typically equipped with only a single spindle, which limits its ability to adapt to form diverse complex contour shapes and cross-sectional variations. This results in low design flexibility, insufficient processing efficiency, and an inability to produce more intricate and precise components.

### SUMMARY

In order to overcome the defects of the existing tube forming methods in process diversity and complexity, the present disclosure unifies high process flexibility and high workpiece complexity, and proposes a new tube forming apparatus and forming method, which can design a variety of regular or irregular cross-section tubes.

The present disclosure adopts the following technical scheme:

A tube multi-point incremental forming apparatus, including a tube feed apparatus and a forming apparatus, the tube feed apparatus and the forming apparatus are installed on a computer numerical control machine tool workbench 8; the forming apparatus includes a large gear 2, a small gear 19 and multiple sets of independent tool devices, each set of tool devices includes a tool head 16 and a tool head motor 18, the tool head 16 is fixed on the large gear 2, which can change its radial angle with the large gear 2 to change initial angles of the three tool heads; each tool head 16 can move independently along an axial direction driving by a corresponding tool head motor 18; meanwhile, the small gear 19 drives the large gear 2 to rotate, so as to drive the multiple sets of tool heads 16 set along a radial direction of the large gear 2 to rotate together to realize a multi-point incremental forming of the tube.

The tube multi-point incremental forming apparatus includes a z-direction guide rail 9, a z-direction screw 10, a three-jaw chuck 11, a chuck bracket 12, a slide plate 13, and a thruster motor 14; the thruster motor 14 is used as a power source to drive the z-direction screw 10 to drive the slide plate 13 to move linearly along the z-direction guide rail 9; the slide plate 13 is fixedly installed with a chuck bracket 12, the chuck bracket is used to support the three-jaw chuck 11; the three-jaw chuck 11 forms a linkage relationship with the z-direction guide rail 9 and the z-direction screw 10 through the slide plate 13, driven by the thruster motor 14, it can move smoothly along a z-axis direction to realize a clamping and propulsion operation of the tube.

The tube multi-point incremental forming apparatus, each set of tool device includes a mold guide seat 15, a tool head 16, a mold mounting plate 17, a tool head motor 18, a forming bracket 20, and a positioning guide sleeve 21, the tool head 16 is fixed on the mold mounting plate 17 through the mold guide seat 15, the forming bracket 20 and the positioning guide sleeve 21, and the mold mounting plate 17 is fixed on the large gear 2, which can change the radial angle between the mold mounting plate and the large gear 2 to change the initial angle of each tool head; the tool head 16 is driven by the corresponding tool head motor 18, and each tool head 16 can move independently along its axial direction.

The tube multi-point incremental forming apparatus, one end of the tool head 16 is fixed on the mold mounting plate 17 through the mold guide seat 15, and the other end is connected to a radial screw pair; two ends of the radial screw pair are respectively connected to the positioning guide sleeve 21 and a transfer ring, and a hollow rotating platform is connected to the positioning guide sleeve 21 through the transfer ring, an upper part of a hollow rotating platform is connected to the tool head motor 18, and the tool head motor 18 cooperates with the hollow rotating platform to drive the tool head to move in the radial direction.

The tube multi-point incremental forming apparatus, the tool head 16 can independently adjust a spacing with a tube driven by the tool head motor 18.

The tube multi-point incremental forming apparatus, the large gear 2 is meshed with the small gear 19, and the small gear 19 is connected to a rotating motor 7 through a gear screw and a coupling, the rotating motor 7 drives the small gear 19, and the small gear 19 drives the large gear 2 to rotate so as to drive the tool head 16 to rotate.

The tube multi-point incremental forming apparatus includes a total of three groups of tool devices.

A multi-point incremental forming method based on the tube multi-point incremental forming apparatus includes the following steps:
1) according to a required machining path, changing a position of the mold mounting plate to change initial angles of the three tool heads;
2) according to a required processing trajectory, driving a tool holder to change a spacing between the tool head and the tube to a required state;
3) driving a slider by a spindle motor of the tube feed apparatus to drive the tube to move, driving a gear by the motor of the forming apparatus to drive the tool head to rotate, and performing an incremental forming of the tube by the tool head.

In this method, after adjusting the spacing between the tool head and the tube to meet a demand, locking the tool head and the tube by using a machine tool operation panel and a driving mechanism.

In the method, before a tube driving mechanism drives the tube to advance, adjusting center positions of the large gear and the three-jaw chuck to make a circle surrounded by the tube and the tool head concentric.

In the method, a tube diameter is set as d, a groove depth of the tube wall is set as e, a fixed screw distance is set as p, and a tube propulsion speed is set as v_{z}, namely, a speed along a z-axis direction, a rotation speed of the gear around a z-axis ω is an angular velocity of the tool head on a circumference, initial angular positions of the three tool heads are θ₁, θ₂ and θ₃, respectively; changes of the positions of the three tool heads with time t is as follows:

For the first tool head:

$$\text{?} ( t ) = \frac{d - 2 e}{2} cos ( ω t + \text{?} )$$

$$\text{?} ( t ) = \frac{d - 2 e}{2} sin ( ω t + {θ}_{1} )$$

$$\text{?} ( t ) = \frac{p ω t}{2 π} = \text{?} t$$

$$\text{?} \text{indicates text missing or illegible when filed}$$

For the second tool head:

$$\text{?} ( t ) = \frac{d - 2 e}{2} cos ( ω t + \text{?} )$$

$$\text{?} ( t ) = \frac{d - 2 e}{2} sin ( ω t + \text{?} )$$

$$\text{?} ( t ) = \frac{p ω t}{2 π} = \text{?} t$$

$$\text{?} \text{indicates text missing or illegible when filed}$$

For the third tool head:

$$\text{?} ( t ) = \frac{d - 2 e}{2} cos ( ω t + \text{?} )$$

$$\text{?} ( t ) = \frac{d - 2 e}{2} sin ( ω t + \text{?} )$$

$$\text{?} ( t ) = \frac{p ω t}{2 π} = \text{?} t$$

$$\text{?} \text{indicates text missing or illegible when filed}$$

The beneficial effects of the present disclosure are as follows:

(1) By operating the mold mounting plate, the position and angle of the plate on the rotary gear can be flexibly adjusted, thereby altering the relative position of the tool head. This allows the operator to quickly optimize the tool head position according to the size, shape, and machining path of the workpiece, enabling a single set of tools to generate different geometric shapes and offering greater forming possibilities.

(2) The main support and the large gear are used to mount and integrate the tool head, the main support is mechanically connected to the machine tool spindle to ensure stable operation of the entire tool device on the spindle. During machining, each tool head engages with the workpiece simultaneously. The motion trajectories of different tools are precisely designed, eliminating the need to repeat the same path multiple times, which improves machining efficiency and reduces error accumulation from repeated processing.

(3) This apparatus and the corresponding forming method can produce tubes with varying shapes and performance requirements based on the shape and size of the tool head. Multiple tool heads can process different sections of the workpiece at the same time. The adjustable design allows tool heads of different sizes and shapes to be quickly assembled and replaced, significantly expanding the apparatus's application range. It can flexibly meet machining demands from small parts to large workpieces and achieve an efficient machining layout.

### BRIEF DESCRIPTION OF THE DRAWINGS

FIG. 1 is a three-dimensional structure diagram of the tube multi-point incremental forming apparatus provided by the present disclosure;

FIG. 2 is a front view of the tube multi-point incremental forming apparatus provided by the present disclosure;

FIG. 3 is a right view of the tube multi-point incremental forming apparatus provided by the present disclosure;

FIG. 4 is a schematic diagram of the relationship between the tube and the forming position of the tool head provided by the present disclosure.

FIG. 5 is a schematic diagram of the tube forming trajectory provided by the present disclosure;

FIG. 6 is a schematic diagram of the forming angle of the tube and tool head provided by the present disclosure.

FIG. 7 is a schematic diagram of a tube forming part provided by the present disclosure;

Marks in the figures: 1—winding wheel, 2—large gear, 3—sling, 4—main support, 5—dust-proof cover, 6—bearing plate, 7—rotating motor, 8—computer numerical control machine tool workbench, 9—z-direction guide rail, 10—z-direction screw, 11—three-jaw chuck, 12—chuck bracket, 13—slider, 14—thruster motor, 15—mold guide seat, 16—tool head, 17—mold mounting plate, 18—tool head motor, 19—small gear, 20—forming bracket, 21—positioning guide sleeve;

### DETAILED DESCRIPTION OF THE EMBODIMENTS

The following is a detailed description of the present disclosure in combination with specific implementation examples.

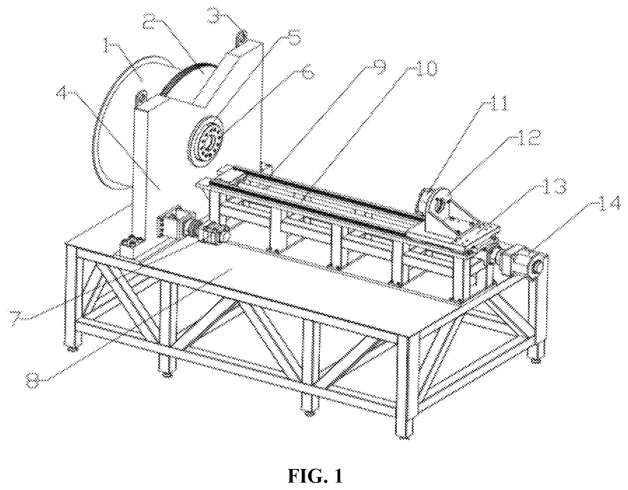

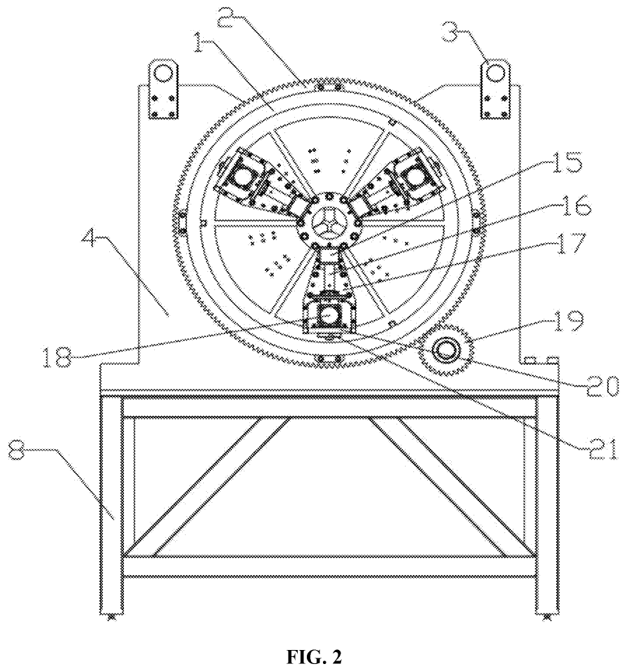

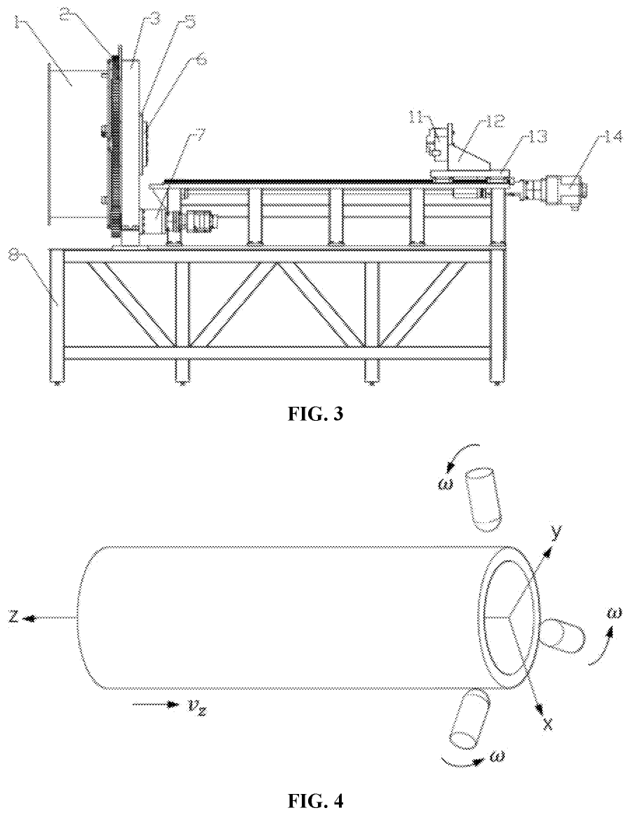

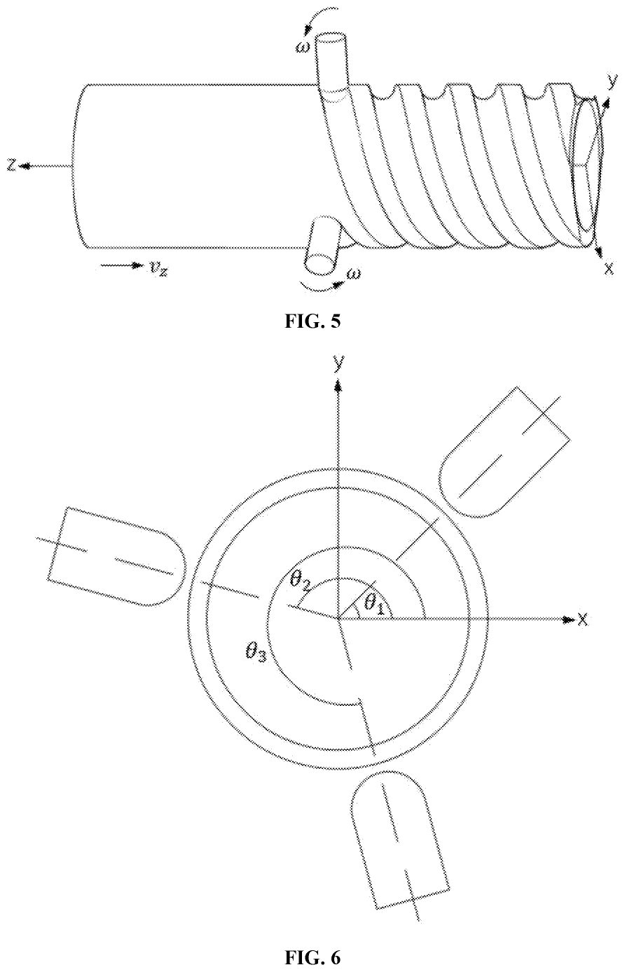

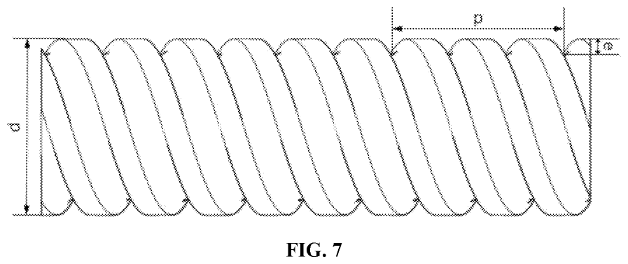

In this embodiment, a tube multi-point incremental forming apparatus is proposed with reference to FIG. 1-FIG. 3, including a tube feed apparatus and a forming apparatus, the tube feed apparatus and the forming apparatus are installed on the computer numerical control machine tool workbench 8.

The tube feed apparatus realizes the precise propulsion of the tube through the coordination between the mechanisms, including a z-direction guide rail 9, a z-direction screw 10, a three-jaw chuck 11, a chuck bracket 12, a slide plate 13, and a thruster motor 14; where the thruster motor 14 is used as a power source to drive the z-direction screw 10 to drive the slide plate 13 to move linearly along the z-direction guide rail 9; the slide plate 13 is fixedly installed with a chuck bracket 12, the chuck bracket is used to support the three-jaw chuck 11; the three-jaw chuck 11 forms a linkage relationship with the z-direction guide rail 9 and the z-direction screw 10 through the slide plate 13, driven by the thruster motor 14, it can move smoothly along a z-axis direction to realize a clamping and propulsion operation of the tube.

the forming apparatus includes a winding wheel 1, a large gear 2, a small gear 19 and three sets of independent tool devices, each set of tool devices includes a mold guide seat 15, a tool head 16, a mold mounting plate 17, a tool head motor 18, and a forming bracket 20, and a positioning guide sleeve 21; the tool head 16 is fixed on the mold mounting plate 17 through the mold guide seat 15, the forming bracket 20 and the positioning guide sleeve 21, the mold mounting plate 17 is fixed on the large gear 2, which can change its radial angle with the large gear 2 to change the initial angle of the three tool heads; each tool head 16 can move independently along the axial direction (that is, the radial direction of the big gear 2 or a certain angle with the radial direction of the big gear 2) driving by the corresponding tool head motor 18, and the meshing of the big and small gears drives the tool head to rotate around the axis of the big gear 2.

More specifically, one end of the tool head 16 is fixed on the mold mounting plate 17 through the mold guide seat 15, and the other end is connected to the radial screw pair; the two ends of the radial screw pair are respectively connected to the positioning guide sleeve 21 and the transfer ring, and the hollow rotating platform is connected to the positioning guide sleeve 21 through the transfer ring. The upper part of the hollow rotating platform is connected to the tool head motor 18, and the tool head motor 18 cooperates with the hollow rotating platform to drive the tool head to move in the radial direction.

In this embodiment, in order to meet the incremental forming requirements of the tube area, the tool head can be replaced, and the tool head of other structures or specifications can be replaced to meet different processing and forming needs. The three tool heads are equipped with tool head motors 18, which can independently adjust the spacing with the tube according to the forming requirements of the tube area.

For the big gear 2, the big gear 2 is engaged with the small gear 19 at the bottom of the main bracket, the small gear 19 is connected to the rotating motor 7 through the gear screw and coupling. The rotating motor 7 drives the small gear 19, and the small gear 19 drives the big gear 2 to rotate and drive the tool head 16 to rotate.

The tube propulsion part and the forming part of the tube multi-point incremental forming apparatus are installed on the spindle of the computer numerical control machine tool workbench, and the tube, which is clamped by the propulsion spacing and speed calibration, is processed.

The machining path is confirmed according to the cross-section shape of the required workpiece, and the initial angle of the three tool heads is changed by changing the distance and angle of the mold mounting plate on the large gear.

According to the required machining path, the position of the mold mounting plate is changed to change the initial angles of the three tool heads. The spacing between the tool head and the tube can also be changed according to the required machining path to drive the tool head motor to adjust to the required state. After adjusting the spacing between the tool head and the tube to meet the demand, the tool head and the tube are locked by using the machine tool operation panel and the driving mechanism.

The driving motor 14 drives the slider to drive the tube to move, the rotating motor 7 drives the gear to drive the tool head rotation, and the tool head performs incremental forming processing on the tube.

Before the tube driving mechanism drives the tube to advance, the center position of the large gear and the three-jaw chuck is adjusted to make the circle surrounded by the tube and the tool head concentric, so as to facilitate the angle correction of the machining process in time and improve the machining accuracy.

For its processing method, the detailed description is as follows:
(1) According to the design drawings and processing requirements of the target parts, the appropriate size of the tool head is selected, and the tube matching the processing task is determined;
(2) Three sets of tool devices with adjustable spacing are assembled, according to the requirements of tube processing, the overall angle of the forming tool is adjusted to ensure that each tool head is in the optimal position during processing and ensure the accuracy of forming;
(3) The tube is clamped on the machine tool, and the concentricity is aligned with the gear where the tool head is located through the coordinate test;
(4) According to the processing requirements, the spacing between the three tool heads and the tube is adjusted by the computer numerical control machine operating panel, and the tube feed speed and the rotation speed of the large gear are specified;
(5) According to the numerical control operation panel drive motor, the machine tool controls the multi-point forming tool to start processing the tube, and the tool head performs progressive processing on the tube at the same time; through synchronous rotation and feed motion, the tube is gradually formed, and the tube is formed according to the preset trajectory.

In this embodiment, the length of the target tube is 180 mm, the diameter is 32 mm, the thickness is 2 mm, the screw distance p of the three thread lines is 6 mm, and the depth of the groove wall e is 1 mm.

The propulsion apparatus is used to set the propulsion speed to push the tube to the processing area.

The angles θ₁, θ₂ and θ₃ of the three tool heads are 0°, 120°, 240°, respectively, the tool head is set to move down 2 mm from the outer wall of the tube along the radial direction.

Assuming that the total processing time is T, the angular velocity of the large gear driving the three tool heads to rotate around the tube is @:

$$ω = \frac{12 π}{T}$$

The position of the three tool heads, namely, the three thread lines, changes with time t as follows:

For the first tool head:

$$\text{?} ( t ) = \frac{d - 2 e}{2} cos ( ω t + \text{?} ) = 15 cos ( \frac{12 π}{T} t )$$

$$\text{?} ( t ) = \frac{d - 2 e}{2} sin ( ω t + \text{?} ) = 15 sin ( \frac{12 π}{T} t )$$

$$\text{?} ( t ) = \frac{p ω t}{2 π} = \frac{36 \text{?}}{T} = \text{?}$$

$$\text{?} \text{indicates text missing or illegible when filed}$$

For the second tool head:

$$\text{?} ( \text{?} ) = \frac{d - 2 e}{2} cos ( ω t + \text{?} ) = 15 cos ( \frac{12 π}{T} t + \frac{2}{3} π )$$

$$\text{?} ( \text{?} ) = \frac{d - 2 e}{2} sin ( ω t + \text{?} ) = 15 cos ( \frac{12 π}{T} \text{?} + \frac{2}{3} π )$$

$$\text{?} ( t ) = \frac{p ω t}{2 π} = \frac{36 \text{?}}{T} = \text{?}$$

$$\text{?} \text{indicates text missing or illegible when filed}$$

For the third tool head:

$$\text{?} ( \text{?} ) = \frac{d - 2 e}{2} cos ( ω t + \text{?} ) = 15 cos ( \frac{12 π}{T} \text{?} + \frac{4}{3} π )$$

$$\text{?} ( \text{?} ) = \frac{d - 2 e}{2} sin ( ω t + \text{?} ) = 15 sin ( \frac{12 π}{T} \text{?} + \frac{4}{3} π )$$

$$\text{?} ( \text{?} ) = \frac{p ω t}{2 π} = \frac{36 \text{?}}{T} = \text{?}$$

$$\text{?} \text{indicates text missing or illegible when filed}$$

Through the adjustment of multi-tool head spacing and the design of replaceable tool heads, the apparatus and forming method can not only flexibly meet the forming requirements of tubes with different shapes and sizes, but also significantly reduce the error accumulation in the process of multiple disassembly and assembly, and greatly improve the processing efficiency. Its simplified process flow and efficient processing mode make the apparatus show strong application potential in the forming and processing of various complex tubes.

It should be understood that ordinary technicians in this field can be improved or transformed according to the above description, and all these improvements and transformations should belong to the scope of protection of the claims attached to the present disclosure.

What is claimed is:

1. A tube multi-point incremental forming apparatus, comprising a tube feed apparatus and a forming apparatus, wherein: the tube feed apparatus and the forming apparatus are installed on a computer numerical control machine tool workbench (8); the forming apparatus comprises a large gear (2), a small gear (19) and multiple sets of independent tool devices; each set of tool devices comprises a tool head (16) and a tool head motor (18); the tool head (16) is fixed on the large gear (2), which can change a radial angle with the large gear (2) to change initial angles of the three tool heads; each tool head (16) can move independently along an axial direction driving by a corresponding tool head motor (18); meanwhile, the small gear (19) drives the large gear (2) to rotate, so as to drive the multiple sets of tool heads (16) set along a radial direction of the large gear (2) to rotate together to realize a multi-point incremental forming of the tube; each set of tool device comprises a mold guide seat (15), a tool head (16), a mold mounting plate (17), a tool head motor (18), a forming bracket (20), and a positioning guide sleeve (21); the tool head (16) is fixed on the mold mounting plate (17) through the mold guide seat (15), the forming bracket (20) and the positioning guide sleeve (21); and the mold mounting plate (17) is fixed on the large gear (2), which can change a radial angle between the mold mounting plate and the large gear (2) to change the initial angle of each tool head; the tool head (16) is driven by a corresponding tool head motor (18), and each tool head (16) can move independently along its axial direction; a tube diameter is set as d, a groove depth of the tube wall is set as e, a fixed screw distance is set as p, and a tube propulsion speed is set as v_{z}, wherein v_{z} is a speed along a z-axis direction, a rotation speed of the gear around a z-axis ω is an angular velocity of the tool head on a circumference, initial angular positions of the three tool heads are θ₁, θ₂ and θ₃, respectively; changes of the positions of the three tool heads with time t is as follows: for a first tool head:
$$\text{?} ( t ) = \frac{d - 2 e}{2} cos ( ω t + \text{?} ) ; \text{?} ( t ) = \frac{d - 2 e}{2} sin ( ω t + \text{?} ) ; \text{?} ( t ) = \frac{p ω t}{2 π} = \text{?} ;$$
$$\text{?} \text{indicates text missing or illegible when filed}$$
for a second tool head:
$${x}_{2} ( t ) = \frac{d - 2 e}{2} cos ( ω t + {θ}_{2} ) ; {y}_{2} ( t ) = \frac{d - 2 e}{2} sin ( ω t + {θ}_{2} ) ; {z}_{2} ( t ) = \frac{p ω t}{2 π} = \text{?} ;$$
$$\text{?} \text{indicates text missing or illegible when filed}$$
for a third tool head:
$${x}_{3} ( t ) = \frac{d - 2 e}{2} cos ( ω t + {θ}_{3} ) ; {y}_{3} ( t ) = \frac{d - 2 e}{2} sin ( ω t + {θ}_{3} ) ; {z}_{3} ( t ) = \frac{p ω t}{2 π} = \text{?} .$$
$$\text{?} \text{indicates text missing or illegible when filed}$$

2. The tube multi-point incremental forming apparatus according to claim 1, wherein the tube feed apparatus comprises a z-direction guide rail (9), a z-direction screw (10), a three-jaw chuck (11), a chuck bracket (12), a slide plate (13), and a thruster motor (14); wherein the thruster motor (14) is used as a power source to drive the z-direction screw (10) to drive the slide plate (13) to move linearly along the z-direction guide rail (9); the slide plate (13) is fixedly installed with a chuck bracket (12), the chuck bracket is used to support the three-jaw chuck (11); the three-jaw chuck (11) forms a linkage relationship with the z-direction guide rail (9) and the z-direction screw (10) through the slide plate (13), driven by the thruster motor (14), can move smoothly along a z-axis direction to realize a clamping and propulsion operation of the tube.

3. The tube multi-point incremental forming apparatus according to claim 1, wherein one end of the tool head (16) is fixed on the mold mounting plate (17) through the mold guide seat (15), and the other end is connected to a radial screw pair; wherein two ends of the radial screw pair are respectively connected to the positioning guide sleeve (21) and a transfer ring, and a hollow rotating platform is connected to the positioning guide sleeve (21) through the transfer ring, an upper part of a hollow rotating platform is connected to the tool head motor (18), and the tool head motor (18) cooperates with the hollow rotating platform to drive the tool head to move in the radial direction.

4. The tube multi-point incremental forming apparatus according to claim 1, wherein the tool head 16 can independently adjust a spacing with a tube driven by the tool head motor 18.

5. The tube multi-point incremental forming apparatus according to claim 1, wherein the big gear (2) is engaged with the small gear (19) at the bottom of the main bracket, the small gear (19) is connected to the rotating motor (7) through a gear screw and a coupling, the rotating motor (7) drives the small gear (19), and the small gear (19) drives the big gear (2) to rotate and drive the tool head (16) to rotate.

6. The tube multi-point incremental forming apparatus according to claim 1, wherein a total of three groups of tool devices.

7. A multi-point incremental forming method based on the tube multi-point incremental forming apparatus according to claim 1, comprising the following steps: S1: according to a required machining path, changing a position of the mold mounting plate to change initial angles of three tool heads; S2: according to a required processing trajectory, driving a tool holder to change a spacing between the tool head and the tube to a required state; and S3: driving a slider by a spindle motor of the tube feed apparatus to drive the tube to move, driving a gear by the motor of the forming apparatus to drive the tool head to rotate, and performing an incremental forming of the tube by the tool head.

8. The method according to claim 7, wherein after adjusting a spacing between the tool head and the tube to meet a demand, the tool head and the tube are locked by using a machine tool operation panel and a driving mechanism.
